(19) United States
(12) Patent Application Publication
(10) Pub. No.: US 2020/0071970 A1
(43) Pub. Date: Mar. 5, 2020

(54) MOTOR VEHICLE CLOSURE PANEL WITH ANTI-PINCH SHIELD AND ANTI-PINCH SHIELD FOR CLOSURE PANELS

(71) Applicant: Magna Closures Inc., Newmarket (CA)

(72) Inventors: Arthur J.W. HENES, Etobicoke (CA); Vesna PAVLOVIC, Kleinburg (CA); Albert LAM, Toronto (CA)

(21) Appl. No.: 16/535,708

(22) Filed: Aug. 8, 2019

Related U.S. Application Data
(60) Provisional application No. 62/764,919, filed on Aug. 15, 2018.

(51) Int. Cl. E05B 81/20; B60J 5/04

(52) U.S. Cl. CPC E05B 81/21; B60J 5/047

(57) ABSTRACT

An anti-pinch shield for a motor vehicle having a front passenger swing door a rear passenger swing door includes a body having a mount surface configured for attachment to at least one of a B-pillar of the motor vehicle, between a trailing rear edge of the front passenger swing door and a leading front edge of a rear passenger swing door, and an A-pillar of the motor vehicle, between the leading front edge of the front passenger swing door and an adjacent front vehicle panel. The body has a non-planar surface facing opposite said mount surface. The non-planar surface has a contour that matches the arc of travel of a respective one of the leading front edge of the rear passenger swing door and the leading front edge of the front passenger swing door.

### CROSS-REFERENCE TO RELATED APPLICATION

This application claims the benefit of U.S. Provisional Application Ser. No. 62/764,919, filed Aug. 15, 2018, which is incorporated herein by way of reference in its entirety.

### FIELD

The present disclosure relates generally to door systems for motor vehicles and, more particularly, to a power swinging vehicle door and anti-pinch devices therefor.

### BACKGROUND

This section provides background information related to the present disclosure which is not necessarily prior art.

Passenger doors on motor vehicles are typically mounted by upper and lower door hinges to the vehicle body for swinging movement about a generally vertical pivot axis. Each door hinge typically includes a door hinge strap connected adjacent to a leading front edge of the passenger door, a body hinge strap connected to the vehicle body, and a pivot pin arranged to pivotably connect the door hinge strap to the body hinge strap and define the pivot axis. Such swinging passenger doors (“swing doors”) have recognized issues such as, for example, when the vehicle is situated on an inclined surface and the swing door either opens too far or swings shut due to the unbalanced weight of the door. To address this issue, most passenger doors have some type of detent or check mechanism integrated into at least one of the door hinges that functions to inhibit uncontrolled swinging movement of the door by positively locating and holding the door in one or more mid-travel positions in addition to a fully-open position. In some high-end vehicles, the door hinge may include an infinite door check mechanism which allows the door to be opened and held in check at any desired open position. One advantage of passenger doors equipped with door hinges having an infinite door check mechanism is that the door can be located and held in any position to avoid contact with adjacent vehicles or structures.

In view of increased consumer demand for motor vehicles equipped with advanced comfort and convenience features, many current vehicles are now provided with passive keyless entry systems to permit locking and release of the passenger doors without the use of traditional key-type manual entry systems. In this regard, some of the more popular features now provided with vehicle closure systems include power locking/unlocking and power release. These “powered” features are typically integrated into a primary latch assembly mounted to the passenger door adjacent a trailing rear edge of the passenger door and which is configured to include a latch mechanism, a latch release mechanism and at least one electric actuator. As is known, movement of the passenger door to its closed position causes the latch mechanism to engage a striker (mounted to the vehicle body) and shift the primary latch assembly into a latched mode. To subsequently release the passenger door for movement from its closed position toward an open position, an electric “power release” actuator can actuate the latch release mechanism to mechanically release the striker from the latch mechanism and shift the primary latch assembly into an unlatched mode.

Typically, power door actuation systems include a power-operated device such as, for example, a power swing door actuator having an electric motor and a rotary-to-linear conversion device that are operable for converting the rotary output of the electric motor into translational movement of an extensible member. In many power door actuator arrangements, the power swing door actuator is mounted to the passenger door and the distal end of the extensible member is fixedly secured to the vehicle body. One example of a door-mounted power door actuation system is shown in commonly-owned U.S. Pat. No. 9,174,517 with a power swing door actuator having a rotary-to-linear conversion device configured to include an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions. Operation of the power swing door actuator is controlled in coordination with the power release operation of the primary latch assembly via the passive keyless entry system.

Some other door actuation systems, known as door presenter systems, are configured to include a power-operated door presenter assembly operable to “present” the door by opening it only a predetermined amount to a partially-open position so as to allow subsequent manual movement of the door to its fully-open position. Presenter systems are commonly used on handleless doors to allow the passenger to grasp the trailing rear edge of the presented door in order to manually swing the door to a fully open position.

While such power door systems function satisfactorily for their intended purpose, one recognized drawback relates to a potential pinch point created between a rear passenger door and a front passenger door. For example, when the rear passenger door is in an open position, and a passenger grasps the trailing rear edge of the front passenger door to open the front passenger door, a gap formed between the leading front edge of the rear passenger door and the trailing rear edge of the front passenger door can create a potential pinch point if while the passenger is grasping the rear trailing edge of the front passenger door, the rear passenger is suddenly closed. In the aforementioned scenario, the leading front edge of the rear passenger door may pinch the passenger's fingers present in the gap against the trailing rear edge of the front passenger door.

In view of the above, there remains a need to develop a handleless power door mechanism which addresses and remedies potential pinch points associated with known power door arrangements, while minimizing the cost and complexity associated therewith.

### SUMMARY

This section provides a general summary of the present disclosure and is not a comprehensive disclosure of its full scope or all of its features, aspects and objectives.

It is an aspect of the present disclosure to provide a power swing door arrangement in motor vehicles having handleless front and rear passenger swing doors that avoids the formation of pinch points between the front and rear passenger swing doors.

It is a further aspect of the present disclosure to provide a power swing door arrangement in motor vehicles having a handleless front passenger swing doors that avoids the formation of pinch points between a leading front edge of the front passenger swing door and an adjacent front vehicle panel.

It is another aspect of the present disclosure to provide an anti-pinch member, referred to hereafter as anti-pinch shield, between a trailing rear edge of a front passenger swing door and a leading front edge of a rear passenger swing door and/or between the leading front edge of the front passenger swing door and an adjacent front vehicle panel to eliminate pinch points therebetween.

It is another aspect of the present disclosure to provide an anti-pinch shield that can be readily assembled to an existing motor vehicle to eliminate a pinch point between a trailing rear edge of a front passenger swing door and a leading front edge of a rear passenger swing door and/or between the leading front edge of the front passenger swing door and an adjacent front vehicle panel.

Based on these and other aspects and objectives of the present disclosure, an anti-pinch shield for a motor vehicle is provided. The anti-pinch shield is configured for attachment between a trailing rear edge of a front passenger swing door and a leading front edge of a rear passenger swing door and/or between the leading front edge of the front passenger swing door and an adjacent front vehicle panel to eliminate pinch points therebetween.

It is a further aspect of the present disclosure to provide the anti-pinch shield as a first member, referred to as primary anti-pinch shield, having a concave surface contoured for close clearance matching travel of the leading front edge of a rear passenger swing door therealong to sweep and push any objects, including fingers of a hand, outwardly from a narrow gap formed between the concave surface and the leading front edge of a rear passenger swing door to avoid pinching the object between the rear passenger swing door and the front passenger swing door.

It is a further aspect of the present disclosure to configure the primary anti-pinch shield for attachment to a B-pillar of the motor vehicle.

It is a further aspect of the present disclosure to configure the primary anti-pinch shield for attachment an A-pillar of the motor vehicle.

It is a further aspect of the present disclosure to provide the anti-pinch shield including a second member, referred to hereafter as secondary anti-pinch shield, configured for attachment to the rear passenger swing door adjacent the leading front edge thereof, with the secondary anti-pinch shield having a convex surface contoured for close clearance matching travel along the concave surface of the primary anti-pinch shield.

It is a further aspect of the present disclosure to attach the anti-pinch shield in a location on the B-pillar that blocks access to a grasping area of the front passenger door when the front passenger swing door is in a closed position to indicate to a passenger that the front passenger door is not in a presented, ready-to-be-opened state, thereby further avoiding an inadvertent pinching of the passengers hand.

It is a further aspect of the present disclosure to provide the first body having at least one through opening extending through the arcuate surface and the mount surface, wherein the at least one through opening has a counterbore extending into the arcuate surface, with the counterbore being configured for receipt of a head of a fastener therein to facilitate attachment of the first body to the B-pillar, with the head of the fastener being recessed from the arcuate surface.

It is a further aspect of the present disclosure to provide the contour of the arcuate surface so that it extends toward and terminates adjacent the trailing rear edge of the front passenger swing door when the front passenger swing door is in a closed position, thereby closing off access to a gap behind the anti-pinch shield.

It is a further aspect of the present disclosure to provide the contour of the arcuate surface so that it extends from adjacent the trailing rear edge of the front passenger swing door, when the front passenger swing door is in the closed position, inwardly along the B-pillar and behind the leading front edge of a rear passenger swing door, when the rear passenger swing door is in a closed position.

It is a further aspect of the present disclosure to provide the contour of the arcuate surface so that it extends toward and terminates adjacent the leading front edge of a rear passenger swing door when the rear passenger swing door is in an open position, thereby closing off access to a gap behind the anti-pinch shield.

It is a further aspect of the present disclosure to provide a motor vehicle having a front passenger swing door pivotably attached to an A-pillar of a vehicle body along a leading front edge of the front passenger swing door and a rear passenger swing door pivotably attached to a B-pillar of the vehicle body along a leading front edge of the rear passenger swing door, and having an anti-pinch shield. The anti-pinch shield includes a first body having a mount surface configured for attachment to at least one of the B-pillar, between a trailing rear edge of the front passenger swing door and the leading front edge of the rear passenger swing door, and the A-pillar of the motor vehicle, between the leading front edge of the front passenger swing door and an adjacent the front vehicle panel. The first body has an arcuate surface facing opposite the mount surface. The arcuate surface is provided having a contour that matches the arc of travel of a respective one of the leading front edge of the rear passenger swing door and the leading front edge of the front passenger swing door in close proximity thereto, thereby minimizing the space between the front and/or rear passenger swing doors and the respective front vehicle panel and trailing rear edge of the front passenger swing door during swinging movement of the front and rear passenger swing doors.

It is a further aspect of the present disclosure to provide a method of blocking a potential pinch region between a leading front edge of a swing door and at least one of a trailing rear edge of an adjacent swing door and an adjacent vehicle panel of a motor vehicle. The method includes providing a first body having a mount surface and an arcuate anti-pinch surface facing away from the mount surface. Further, attaching the mount surface of the first body to a fixed body member of the motor vehicle, adjacent the leading front edge of the swing door, and adjacent at least one of the trailing rear edge and the adjacent vehicle panel.

It is a further aspect of the method to include providing the arcuate surface having a contour that matches an arc of travel of the leading front edge of the swing door.

It is a further aspect of the method to include attaching the mount surface of the first body to a B-pillar of the motor vehicle.

It is a further aspect of the method to include attaching the mount surface of the first body to an A-pillar of the motor vehicle.

It is a further aspect of the method to include attaching a second mount surface of a second body to a rear passenger swing door adjacent the leading front edge of the rear passenger swing door and providing the second body having a second contour shaped for close matching travel along the arcuate anti-pinch surface of the first body as the rear passenger swing door moves between an open and closed position.

It is a further aspect of the method to include providing the arcuate anti-pinch surface having a concave contour and providing the second contour having a convex contour shaped for close matching travel along of the concave contour as the rear passenger swing door moves between an open and closed position.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 is a side view of an example motor vehicle equipped with an anti-pinch shield constructed in accordance with the teachings of the present disclosure, with the anti-pinch shield being situated between at least one of a front passenger swing door and a vehicle body panel and/or between the front passenger swing door and a rear passenger swing door;

FIG. 2 is a broken away side view of the front passenger door shown in FIG. 1, with various components removed for clarity purposes only, illustrating a non-limiting example of a power door actuation system of the door;

FIG. 3 is a fragmentary side view of the motor vehicle of FIG. 1 showing a rear passenger swing door in an open position and illustrating an anti-pinch shield attached to a B-pillar to eliminate a pinch point between the front passenger swing door and the rear passenger swing door;

FIG. 4 is a view similar to FIG. 3 with the front and rear passenger swing doors removed from the motor vehicle to better illustrate the anti-pinch shield attached to the B-pillar;

FIG. 5 is an enlarged view of the B-pillar of FIG. 4 illustrating the anti-pinch shield attached thereto;

FIG. 6 is a top sectional view looking down along the B-pillar, without an anti-pinch shield attached thereto, illustrating a potential pinch point between a trailing rear edge of the front passenger swing door and a leading front edge of the rear passenger swing door;

FIG. 7 is a view similar to FIG. 6 taken generally along the line B-B of FIG. 3 illustrating the anti-pinch shield fixed to the B-pillar to eliminate the potential pinch point between the trailing rear edge of the front passenger swing door and the leading front edge of the rear passenger swing door;

FIG. 8 is a view similar to FIG. 7 taken generally along the line C-C of FIG. 3;

FIG. 9 is a view similar to FIG. 8 taken generally along the line D-D of FIG. 3;

FIG. 10 is a front elevation view of the anti-pinch shield of FIG. 3;

FIG. 11 is a top view of the anti-pinch shield of FIG. 3;

FIG. 12 is a rear elevation view of the anti-pinch shield of FIG. 3;

FIG. 13 is a bottom view of the anti-pinch shield of FIG. 3;

FIGS. 14A-14D illustrate schematic top views of an object being swept by the leading front edge of the rear passenger door along the anti-pinch shield fixed to the B-pillar as the rear passenger moves from an open position (FIG. 14A) toward a closed position (FIG. 14D);

FIG. 15 is a top sectional view looking down along the B-pillar illustrating a first anti-pinch shield fixed to the B-pillar and a second anti-pinch shield fixed to the rear passenger door for close matching travel along the first anti-pinch shield to eliminate the potential pinch point between the trailing rear edge of the front passenger swing door and the leading front edge of the rear passenger swing door in accordance with another aspect of the disclosure; and

FIG. 16 is a flow diagram illustrating a method of blocking a potential pinch region between at least one of a front passenger swing door and a vehicle body panel and/or between the front passenger swing door and a rear passenger swing door.

### DETAILED DESCRIPTION OF EXAMPLE EMBODIMENTS

In general, several example embodiments of an anti-pinch mechanism for a motor vehicle swing door constructed in accordance with the teachings of the present disclosure will now be disclosed. Each of the example embodiments is provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, will-known device structures, and well-known technologies are described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

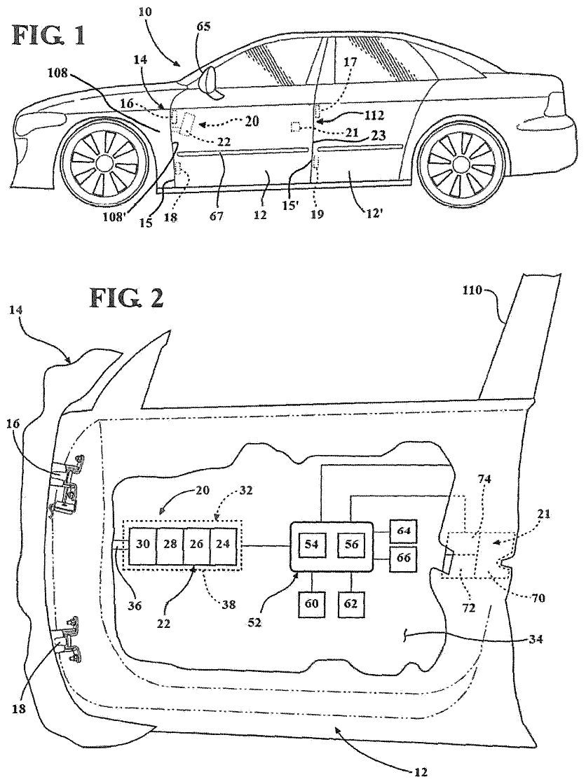

To better describe and illustrate the inventive aspects of the present disclosure, initial reference is directed to FIG. 1 which generally shows an example motor vehicle 10. Motor vehicle 10 includes a front closure panel, also commonly referred to as closure member, such as a front passenger swing door, and referred to as a front passenger door 12, by way of example and without limitation, pivotably mounted to a front pillar segment 11 (A-pillar) vehicle body 14 adjacent a leading front edge 15 of front passenger door 12 via upper and lower hinges 16 and 18 for swinging movement between a closed position (shown) and a fully-open position. Motor vehicle 10 is also shown including a rear closure panel, such as a rear passenger swing door, and referred to as a rear passenger door 12′ pivotably mounted to a central pillar segment 13 (B-pillar) of vehicle body 14 adjacent a leading front edge 15′ of rear passenger door 12′ via upper and lower hinges 17 and 19 for swinging movement between a closed position (shown) and a fully-open position. Front door 12 and rear door 12′ are shown to be configured without outside door handles so as to each define a “handleless” closure member that is part of a closure panel system, also referred to as power door actuation system 20.

Power door actuation system 20 is shown schematically to include a latch assembly 21 and a presenter assembly 22. Latch assembly 21 is mounted to front door 12 and includes (in this non-limiting configuration) a latch mechanism configured to engage a striker (not shown) provided on the vehicle body 14, a power-operated latch release mechanism, and a power-operated lock mechanism. Latch assembly 21 is defined to be operating in a locked-latched mode when the latch mechanism is latched and the lock mechanism is locked for holding front door 12 in a locked-closed position. Latch assembly 21 is also defined to be operating in an unlocked-latched mode when the latch mechanism is latched and the lock mechanism is unlocked for holding front door 12 in an unlocked-closed position. Finally, latch assembly 21 is defined to be operating in an unlatched mode when the latch mechanism is released and the lock mechanism is unlocked so as to permit movement of front door 12 from its unlocked-closed position toward a fully-open position. At least one electrically-powered latch actuator is provided in association with latch assembly 21 for controlling operation of the latch release and lock mechanism to provide a power release function and a power lock function. An activation command signal generated by an authentication device is used by a latch controller to initiate operation of the electric latch actuator to provide the desired power release and power lock functions. The authentication device is associated with a passive keyless entry system and may include, without limitation, a key fob, a contact or non-contact interface provided on front door 12, and a voice recognition interface. The specific details of latch assembly 21 and its activation protocol are not required as those skilled in the art understand the provisions of the power release and power lock functionality discussed above.

Power door actuation system 20 is diagrammatically shown in FIG. 2 to include a power-operated swing door presenter mechanism, also referred to as power swing door actuator 32, comprised of an electric motor 24, a reduction geartrain 26, a slip clutch 28, and a drive mechanism 30 which together define powered door presenter assembly 22 that is mounted within an interior chamber 34 of door 12. Examples of presenter assemblies are shown in commonly-owned U.S. Publication No. US 2017/0292310, titled “Power Swing Door Actuator With Articulating Linkage Mechanism”, the entire application being incorporated by reference herein. Presenter assembly 22 also includes a connector mechanism 36 configured to connect an extensible member of drive mechanism 30 to a portion of vehicle body 14. Other types of presenter mechanisms may be provided, such as those whereby the connector mechanism 36 remains disconnected with from a portion of vehicle body 14 and is configured to urge or “push” the door 12 to a “presented position” (e.g. to create a 20 mm to 70 mm gap between a trailing rear door edge 23 and the vehicle body 14). Presenter assembly 22 further includes a support structure, such as an actuator housing 38, configured to be secured to door 12 within chamber 34 and to enclose electric motor 24, reduction geartrain 26, slip clutch 28 and drive mechanism 30 therein. As also shown, an electronic control system 52 is in communication with electric motor 24 for providing electric control signals thereto. Electronic control system, also referred to electronic control module 52, may include a microprocessor 54 and a memory 56 having executable computer readable instructions stored thereon for execution by the microprocessor 54. Electronic control module 52 may include hardware and/or software components. Electronic control module 52 can be integrated into, or directly connected to, actuator housing 38 or may be a remotely located device within interior door chamber 34 or may be integrated into latch assembly 21.

Although not expressly illustrated, electric motor 24 can include Hall-effect sensors for monitoring a position and speed of vehicle door 12 during movement between its open and closed positions. For example, one or more Hall-effect sensors may be provided and positioned to send signals to electronic control module 52 that are indicative of rotational movement of electric motor 24 (e.g. a motor shaft) and indicative of the rotational speed of electric motor 24, e.g., based on counting signals from the Hall-effect sensor detecting a target on a motor output shaft. In situations where the sensed motor speed is greater than a threshold speed and where the current being supplied to the motor 24 (e.g. as detected by a current sensor or sensing circuitry) registers a significant change in the current draw, electronic control module 52 may determine that the user is manually moving door 12 while motor 24 is also operating, thus moving vehicle door 12. Electronic control module 52 may then send a signal to electric motor 24 to stop motor 24 and may even disengage slip clutch 28 (if provided) to facilitate manual override movement. Conversely, when electronic control module 52 is in a power open or power close mode and the Hall-effect sensors indicate that a speed of electric motor 24 is less than a threshold speed (e.g., zero) and a current spike is registered either directly or indirectly by microprocessor 54 and/or any current sensing circuitry, electronic control module 52 may determine that an obstacle is in the way of vehicle door 12, in which case the electronic control system may take any suitable action, such as sending a signal to turn off electric motor 24. As such, electronic control module 52 receives feedback from the Hall-effect sensors to ensure that a contact obstacle has not occurred during movement of vehicle door 12 from the closed position to the partially-open position, or vice versa. Other position sensing techniques to determine that the vehicle door 12 is being moved, either by the electrical motor 24 and/or a manual user control are also possible.

As is also schematically shown in FIG. 2, electronic control module 52 can be in communication with a remote key fob 60 and/or with an external door-mounted switch 62 (contact such as a piezoelectric switch, or contactless such as a capacitive sensor) for receiving a request from a user to open or close vehicle door 12. Put another way, electronic control module 52 receives a command signal from either remote key fob via a key fob sensor 60 and/or door switch 62 to initiate an opening or closing of vehicle door 12. Upon receiving a command, electronic control module 52 proceeds to provide a signal to electric motor 24 in the form of a pulse width modulated voltage (for speed control) as an example to turn on motor 24 and initiate pivotal swinging movement of vehicle door 12. While providing the signal, electronic control module 52 also obtains feedback from the Hall-effect sensors of electric motor 24 to ensure that a contact obstacle has not occurred. If no obstacle is present, motor 24 will continue to generate a rotational force to actuate spindle drive mechanism 30. Once vehicle door 12 is positioned at the desired location, motor 24 is turned off and the “self-locking” gearing associated with gearbox 26 causes vehicle door 12 to continue to be held at that location, thereby providing an automatic door checking function. If a user tries to move vehicle door 12 to a different operating position, electric motor 24 will first resist the user's motion (thereby replicating a door check function) and eventually release and allow door 12 to move to the newly desired location. Again, once vehicle door 12 is stopped, electronic control module 52 will provide the required power to electric motor 24 to hold it in that position. If the user provides a sufficiently large motion input to vehicle door 12 (i.e., as is the case when the user wants to close the door), electronic control module 52 will recognize this motion via the Hall effect pulses and proceed to execute a full closing operation for vehicle door 12.

Electronic control module 52 can also receive an additional input from proximity sensor, such as an ultrasonic sensor 64 positioned on a portion of vehicle door 12, such as on a door mirror 65 or the like. Ultrasonic sensor 64 detects if an obstacle, such as another car, tree, or post, is near or in close proximity to vehicle door 12. If such an obstacle is present, ultrasonic sensor 64 will send a signal to electronic control module 52 and electronic control module 52 will proceed to turn off electric motor 24 to stop movement of vehicle door 12, thereby preventing vehicle door 12 from hitting the obstacle. This provides a non-contact obstacle avoidance system. In addition, or optionally, a contact obstacle avoidance system, such as a pinch detection system, can be placed in vehicle 10 which includes a contact sensor 66 mounted to door, such as in association with molding component 67, and which is operable to send a signal to controller 52 that an obstacle is detected, such as a user's finger detected in a gap between the vehicle body 14 and the door 12. Although the electronic pinch detection can be provided if desired, a simplified real-time anti-pinch prevention mechanism, referred to hereafter as anti-pinch shield 100 is provided in accordance with the disclosure, discussed further below, which functions mechanically and simply to prevent an object, such as a user's finger(s) from being pinched in a gap between the vehicle body 14 and the door 12.

Power door actuation system 20 is also shown schematically in FIG. 2 with latch assembly 21 having a latch mechanism 70, a latch release mechanism 72, and a power-operated release actuator such as an electric power release motor 74. For purposes of illustration only control module 52 is shown in communication with electric power release motor 74 so as to also act as a latch controller for controlling operation of latch assembly 21. Control module 52 can be an integrated configuration or a pair of distinct controllers associated with presenter assembly 22 and latch assembly 21. Key fob sensor 60 and/or door switch 62 are again used to authenticate the user and control the power release (and power lock) function.

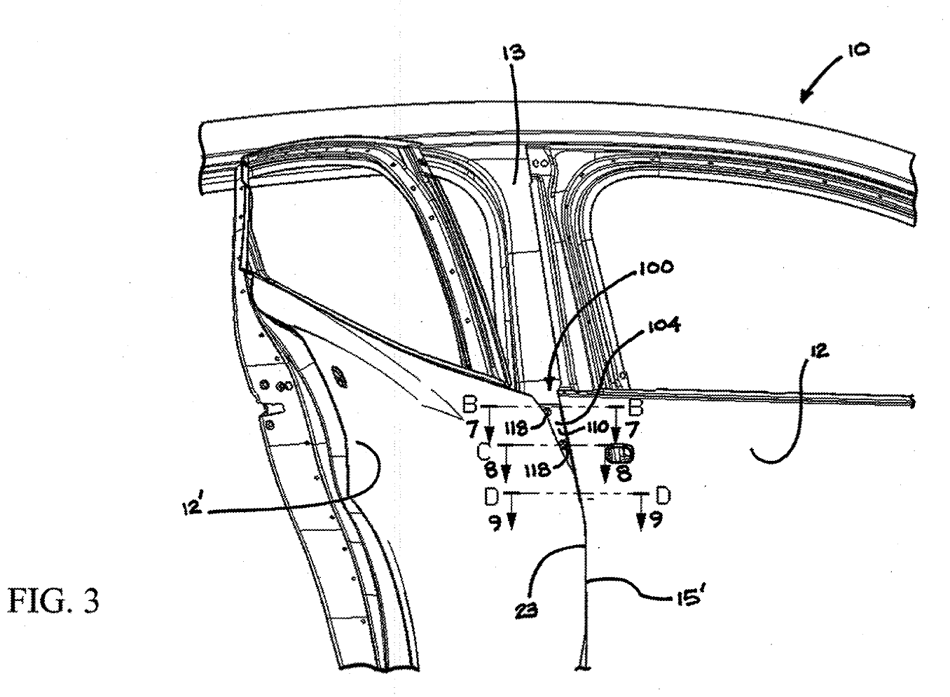

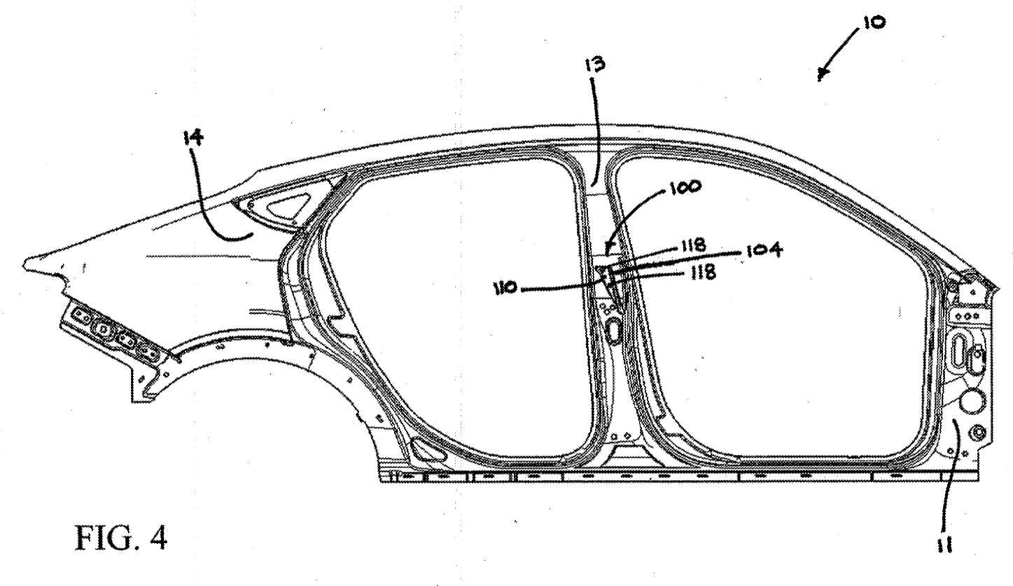

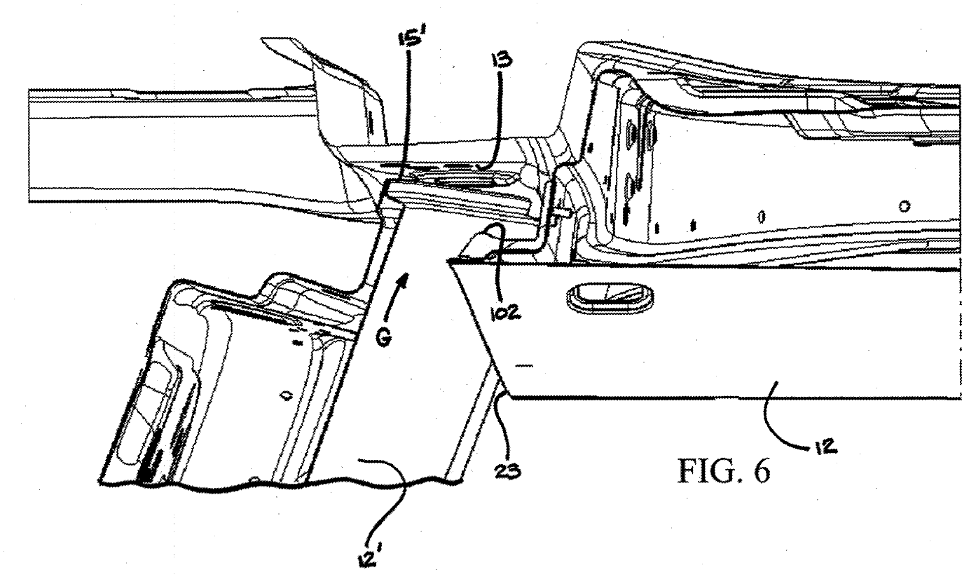

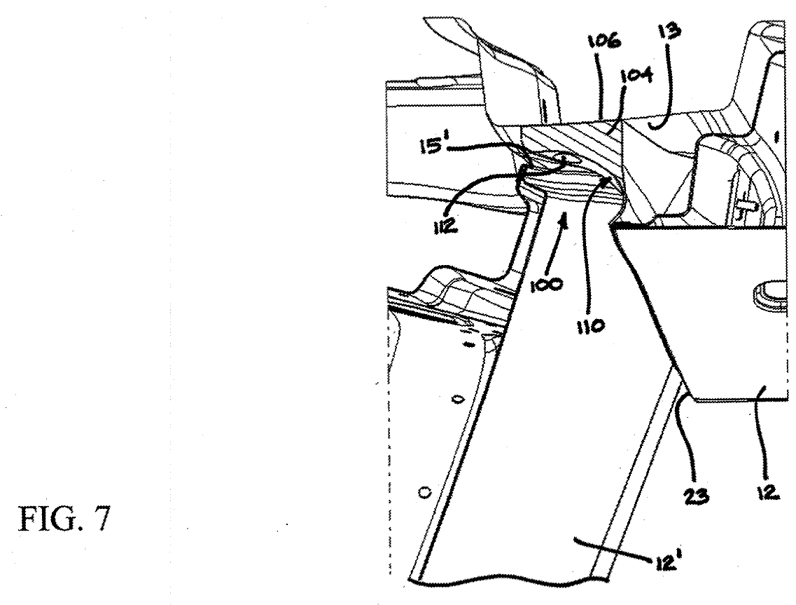

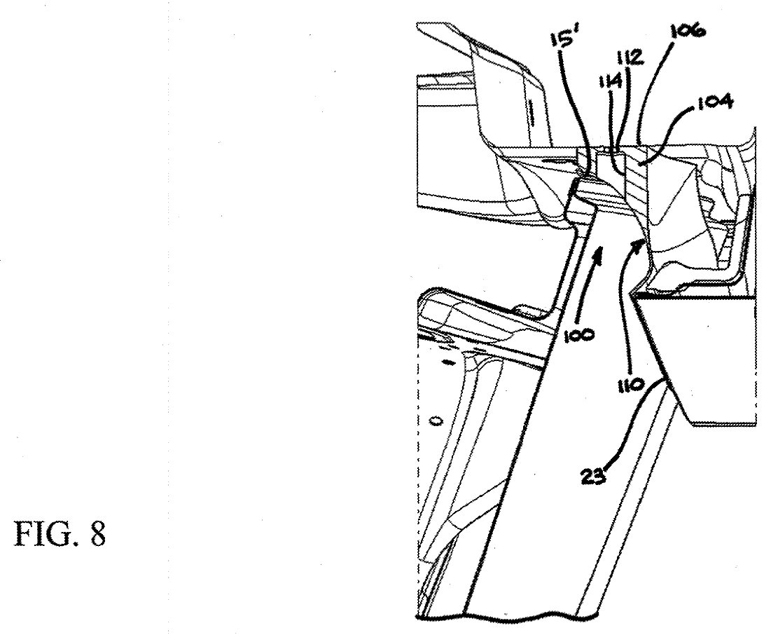

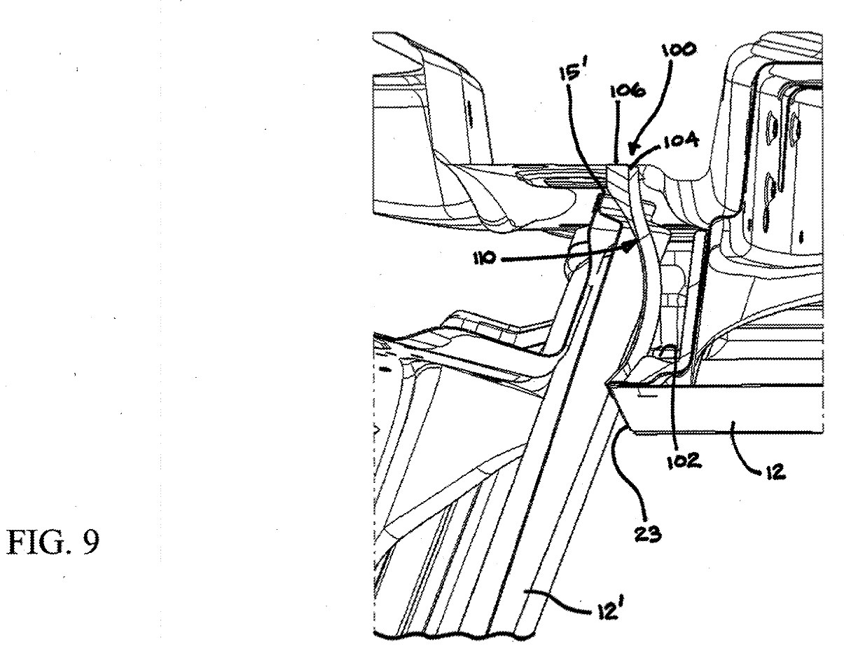

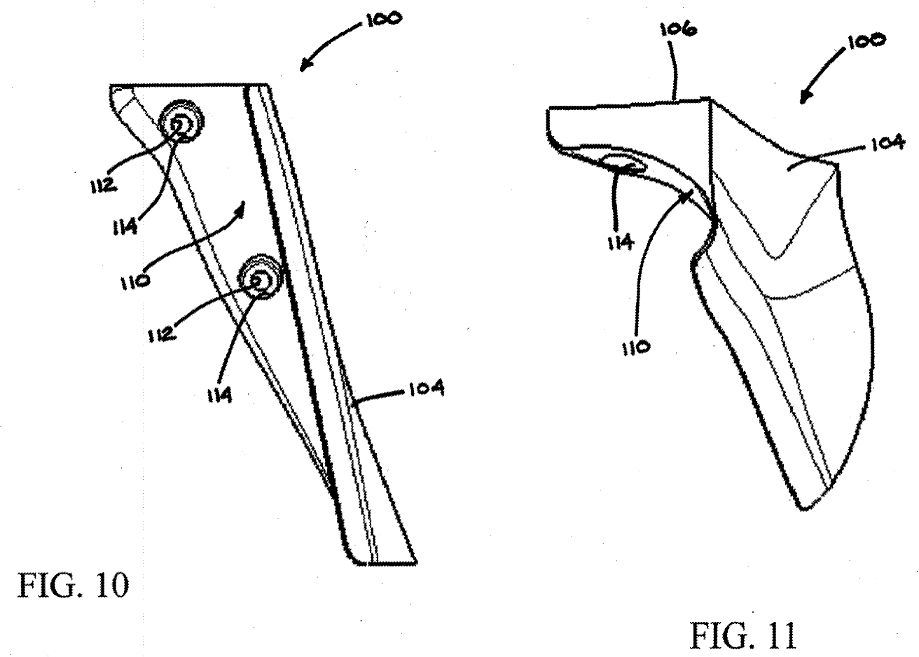

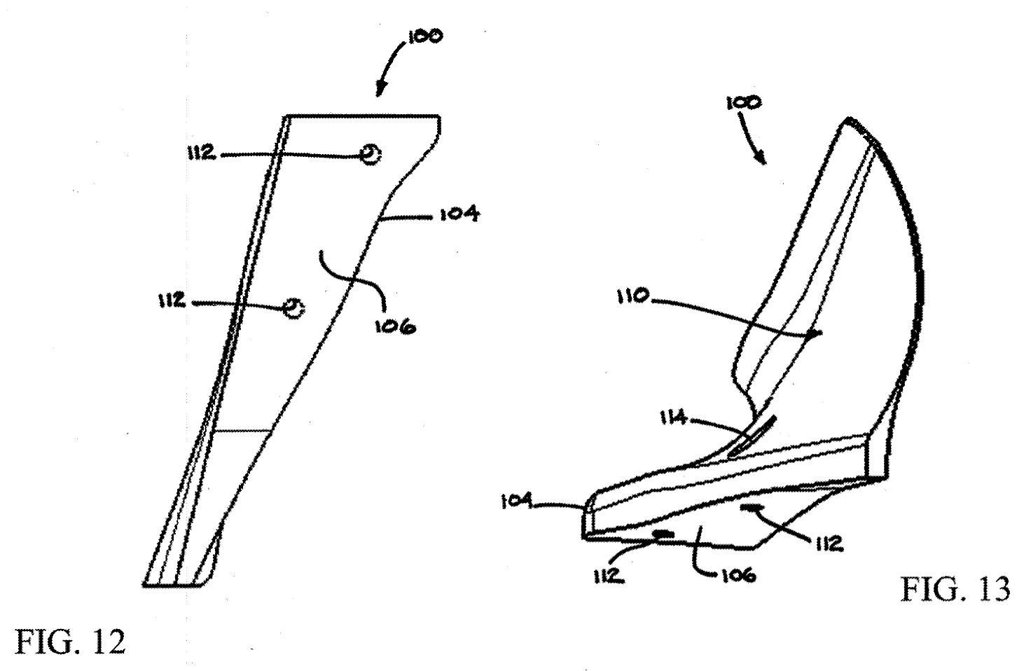

Referring to FIGS. 3-15, further discussion regarding anti-pinch shield 100 follows. In FIG. 3, the rear passenger door 12′ is shown in an open position with the front passenger door 12 shown in a closed position, thereby establishing a potential gap G (FIG. 6, shown anti-pinch shield 100) between the leading front edge 15′ of rear passenger door 12′ and the trailing rear edge 23 of front passenger door 12, shown as being generally triangular, by way of example and without limitation. The gap G shown in FIG. 6 presents a potential pinch region P, also referred to as pinch area, pinch location or pinch point, for an object O disposed therein, such as a user's fingers grasping a grasp area 102 of front passenger door 12 (FIG. 6 illustrates user's hand/fingers disposed therein without anti-pinch shield 100 in place), such as an internal handle or grip surface, by way of example and without limitation illustratively provided on an inwardly facing surface 25 of the swing door 12, which may be provided in lieu of a handle provided on the outwardly facing surface 27 of the swing door 12, in a configured where the swing door 12 is a handless swing door. However, with the anti-pinch shield 100 disposed within the gap G, the gap G is closed off (filled), and thus, the potential pinch point P is blocked, and thus, eliminated, as discussed further below.

The anti-pinch shield 100 has a first body 104 providing a mount surface 106 configured for fixed attachment to a body 14 of the motor vehicle 10, between at least one leading front edge 15, 15′ of at least one of the respective front and rear swing doors 12, 12′, and one of a trailing rear edge 23 of an adjacent swing door 12 and an adjacent vehicle panel 108. In one non-limiting embodiment, the mount surface 106 of one anti-pinch shield 100 can be attached to at least one of the B-pillar 13 of the motor vehicle 10, between and/or adjacent the trailing rear edge 23 of the front passenger swing door 12 and the leading front edge 15′ of the rear passenger swing door 12′, and the A-pillar 11 of the motor vehicle 10, between the leading front edge 15 of the front passenger swing door 12 and an adjacent trailing edge 108′ of a front vehicle panel 108, such as a front quarter panel, such as that forming a front fender of the motor vehicle 10, by way of example and without limitation. The first body 104 has a shape the fills or substantially fills the gap G, shown as being generally triangular to match the peripheral shaped of the gap G. The first body 104 has an arcuate surface 110, shown as being concave, facing opposite the mount surface 106 outwardly toward an outer environment. The arcuate surface 110 has a geometric contour that matches or substantially matches (closes approximates by not identical) the arc of travel of a respective one of the leading front edge 15′ of the rear passenger swing door 12′ and the leading front edge 15 of the front passenger swing door 12. As such, the contour of the arcuate surface 110 has a smooth radius, whether constant or varying, such as a logarithmic curve. By way of example and without limitation, the anti-pinch shield 100 is shown disposed on the B-pillar 13, though it is to be recognized that, as discussed above, it can also be disposed on the A-pillar 11.

To facilitate attachment of the first body 104 to the respective A and/or B pillar 11, 13, the first body 104 has at least one, and shown as a pair of through openings 112, by way of example and without limitation, extending through the arcuate surface 110 and the mount surface 106. The through openings 112 have a counterbore 114 extending into the arcuate surface 110, wherein the counterbores 114 are sized and configured for full receipt of a head 116 of a fastener 118 therein. As such, the head 116 of the fastener 118 is fully recessed below the arcuate surface 110 to avoid interference with the leading front edge 15′ of the rear passenger door 12′.

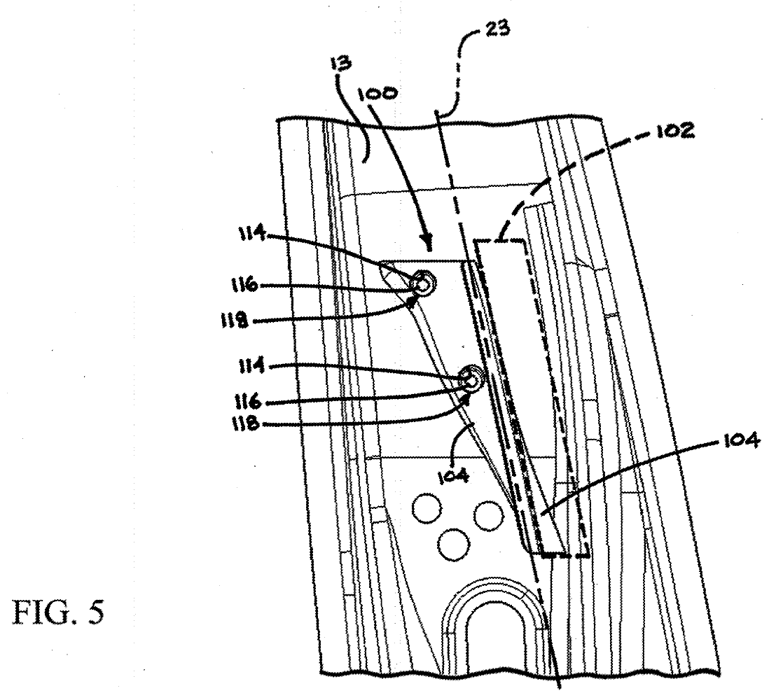

The arcuate surface 110 of the anti-pinch shield 100, as shown in FIGS. 5, and 7-9, is configured to extend outwardly from the B-pillar 13 toward, and terminate immediately adjacent, the trailing rear edge 23 of the front passenger swing door 12 when the front passenger swing door 12 is in a closed position. Further yet, the arcuate surface 110 extends from immediately adjacent the trailing rear edge 23 of the front passenger swing door 12, when the front passenger swing door is in the closed position, and inwardly from the trailing rear edge 23, generally along the width (extending from a front end of the vehicle toward a rear end of the vehicle) B-pillar, behind and beyond the leading front edge 15′ of the rear passenger swing door 12′ away from the trailing rear edge 23 of the front passenger swing door 12, when the rear passenger swing door 12′ is in a closed position. Further, when the rear passenger swing door 12′ is in an open position, the arcuate surface 110 is configured to extend from the trailing rear edge 23 of the front passenger swing door 12, while in the closed position, toward and terminate adjacent the leading front edge 15′ of a rear passenger swing door. As such, the anti-pinch shield 100 acts to block off and prevent access to the grasp area 102 while the front passenger swing door 12 is in a closed, non-presented position while the rear passenger swing door 12′ is open. Accordingly, a user can readily see the grasp area 102 is inaccessible, and thus, is alerted that the front passenger swing door 12 is not in the presented position, and thus, the user is not tempted to grasp the handle 102, thereby avoiding a potential pinch scenario with the pinch region P. It is to be recognized that the likelihood of a pinch scenario is reduced when the front passenger swing door 12 is in the presented position.

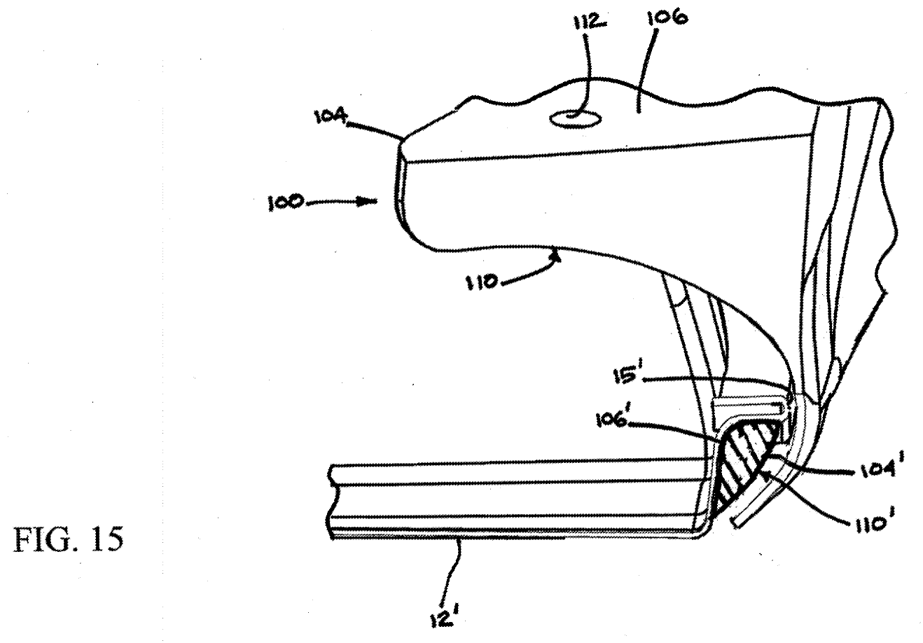

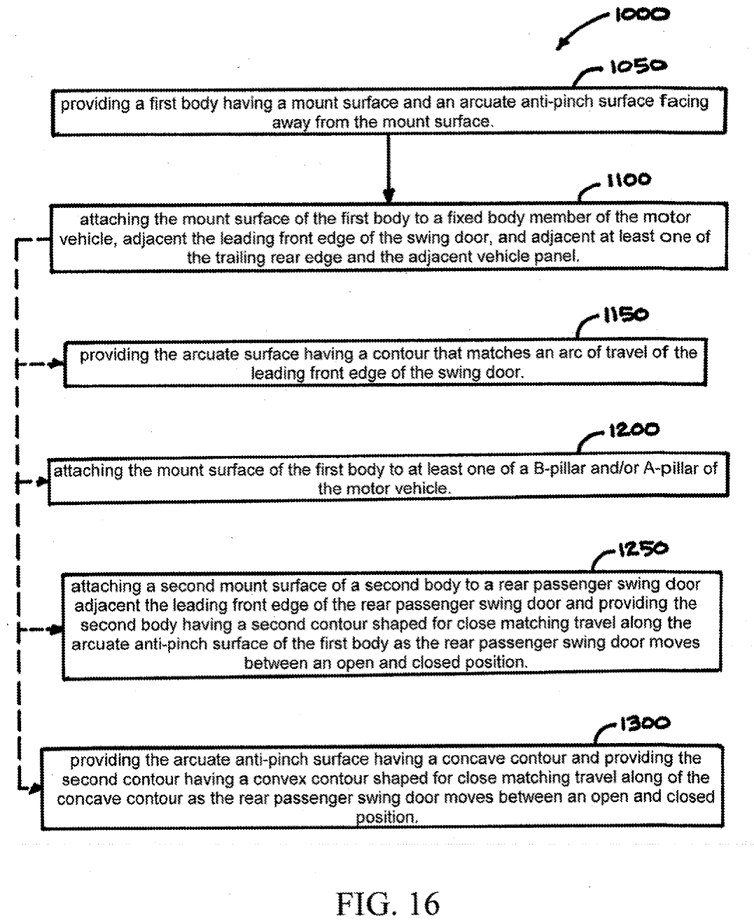

As shown in FIG. 15, the anti-pinch shield 100 can further include a second body 104′ configured for attachment to the rear passenger swing door 12′. The second body 104′ has a second mount surface 106′ configured for attachment to the rear passenger swing door 12′ immediately adjacent the leading front edge 15′ of the rear passenger swing door 12′. The second body 104′ has a second arcuate surface 110′ facing opposite and away from the second mount surface 106′. The second arcuate surface 110′ has a second contour, shown as being convex, shaped for close matching travel along the arcuate surface 110 of the first body 104, in narrowly spaced relation therefrom, as the rear passenger swing door 12′ moves between the open and closed positions. For example, such a close matching travel may reduce the gap between the arcuate surface and the swing door to a distance that is smaller than those of human fingers. Accordingly, minimal space, with a slight clearance, is present between the matching, closely conforming surfaces 110, 100′, thereby preventing objects, such as a user's fingers, from getting caught and pinched therebetween.

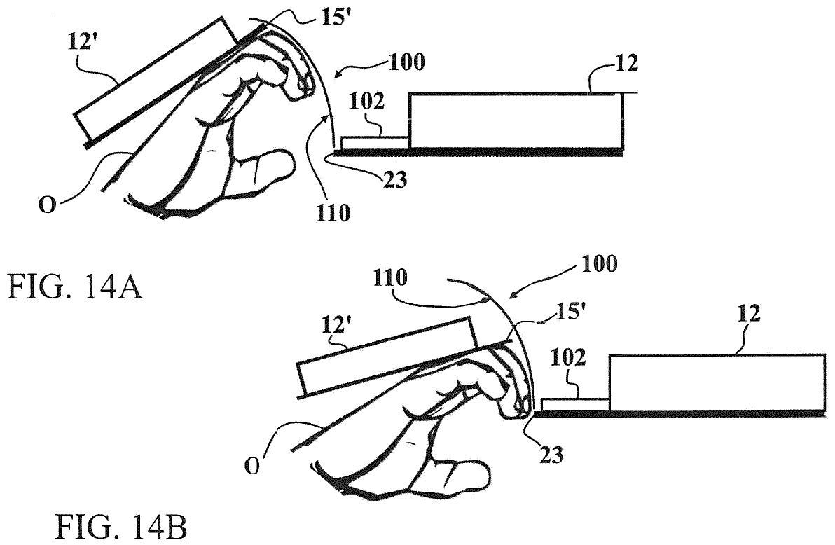

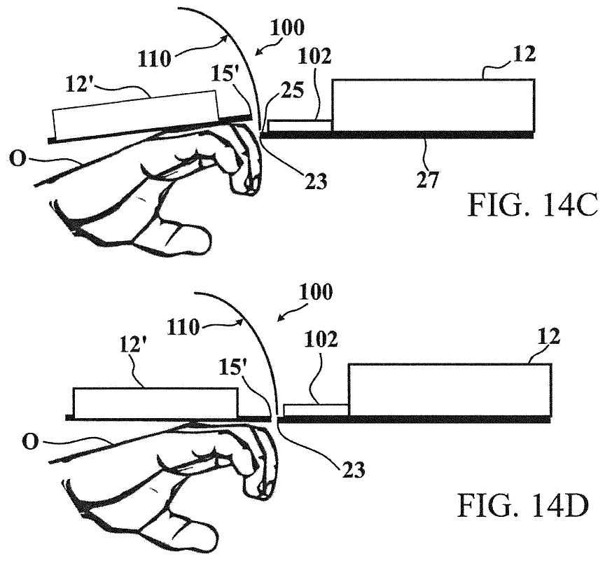

In FIGS. 14A-14C, a schematic illustration is shown of an object O being swept along an arcuate surface 110 of an anti-pinch shield 100 as the rear passenger swing door 12′ closes. As can be seen, the grasp area 102 (handle), while the front passenger swing door 12 is closed and not presented, is inaccessible as a result of a barrier formed by the anti-pinch shield 100 extending into close relation, such as line-to-line or slight clearance relation, with the trailing rear edge 23 of the front passenger swing door 12. Accordingly, the object O (e.g. user's fingers) are kept away from the grasp area 102, and if the rear passenger swing door 12′ is closed while the object O is present, the leading front edge 15′ sweeps the object O along the arcuate surface 110 without causing the object O to be pinched, as shown in progressive closing views of FIG. 14A (rear passenger swing door 12′ open) through 14D (rear passenger swing door 12′ closed). FIG. 14 illustratively show the anti-pinch shield 100 terminating adjacent the trailing rear edge 23 to cover the inwardly facing surface 25 to eliminate a pinch point between the inwardly facing surface 25 and the leading front edge 15′, and in other words to guide the fingers away from the inwardly facing surface 25 of the trailing rear edge 23.

It is to be recognized that the anti-pinch shield 100 is readily attachable to a B-pillar 13 of an existing vehicle not originally equipped with the anti-pinch shield 100, or it can be assembled at an original equipment manufacturer. The anti-pinch shield 100 functions mechanically in real-time to sweep the object O outwardly without pinching the object O, and thus, reliance on signals from sensors is negated, thereby doing away with inherent delays present with sensors. Further, the anti-pinch shield is economical in manufacture, such as via a molding process, by way of example and without limitation, and is further economical in assembly.

It is to be further recognized, as discussed above, the anti-pinch shield 100 can be attached to the A-pillar 11 of the motor vehicle 10, between the leading front edge 15 of the front passenger swing door 12 and an adjacent trailing edge 108′ of a front vehicle panel 108. Although this region is not considered a grasp area, as discussed above for the B-pillar grasp area 102, it can still present a pinch point. Accordingly, the anti-pinch shield 100 discussed above can be shaped having an outer periphery, as desired, to fill the geometric shape of a potential pinch area between the front passenger swing door 12 and the adjacent front vehicle panel 108.

In accordance with another aspect of the disclosure, a method 1000 of blocking a potential pinch region P between a leading front edge 15, 15′ of a swing door 12, 12′ and at least one of a trailing rear edge 23, 108′ of an adjacent swing door, such as front passenger swing door 12, and an adjacent vehicle panel 108 of a motor vehicle 10. The method 1000 includes a step 1050 of providing a first body 104 having a mount surface 106 and an arcuate anti-pinch surface 110 facing away from the mount surface 106. Further, a step 1100 of attaching the mount surface 106 of the first body 104 to a fixed body member 11, 13 of the motor vehicle 10, adjacent the leading front edge 15, 15′ of the swing door 12, 12′, and adjacent at least one of the trailing rear edge 23 and the adjacent vehicle panel 108.

It is a further aspect of the method 1000 to include a step 1150 of providing the arcuate surface 110 having a contour that matches an arc of travel of the leading front edge 15, 15′ of the swing door 12, 12′.

It is a further aspect of the method 1000 to include a step 1200 of attaching the mount surface 106 of the first body 104 to at least one of a B-pillar 13 and/or A-pillar 11 of the motor vehicle 10.

It is a further aspect of the method 1000 to include a step 1250 of attaching a second mount surface 106′ of a second body 104′ to a rear passenger swing door 12′ adjacent the leading front edge 15′ of the rear passenger swing door 12′ and providing the second body 104′ having a second contour shaped for close matching travel along the arcuate anti-pinch surface 110 of the first body 104 as the rear passenger swing door 12′ moves between an open and closed position.

It is a further aspect of the method 1000 to include a step 1300 of providing the arcuate anti-pinch surface 110 having a concave contour and providing the second contour having a convex contour shaped for close matching travel along of the concave contour as the rear passenger swing door 12′ moves between an open and closed position

The foregoing description of the several embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Those skilled in the art will recognize that concepts disclosed in association with the example detection system can likewise be implemented into many other systems to control one or more operations and/or functions.

What is claimed is:

1. An anti-pinch shield for a motor vehicle having a swing door, comprising:
a first body having a mount surface configured for attachment to a body of the motor vehicle, between a leading front edge of the swing door, and one of a trailing rear edge of an adjacent swing door and an adjacent vehicle panel, said first body having an arcuate surface facing the leading front edge, said arcuate surface having a contour that matches an arc of travel of the leading front edge of the swing door.

2. The anti-pinch shield of claim 1, wherein the leading front edge is on a rear passenger swing door and the trailing rear edge is on a front passenger swing door, said first body being configured for attachment to a B-pillar of the motor vehicle adjacent the leading front edge and the trailing rear edge.

3. The anti-pinch shield of claim 2, wherein said first body has at least one through opening extending through said arcuate surface and said mount surface, said at least one through opening having a counterbore extending into said arcuate surface, said counterbore being configured for receipt of a head of a fastener therein to facilitate attachment of said first body to the B-pillar, with the head of the fastener being recessed from said arcuate surface.

4. The anti-pinch shield of claim 2, wherein said arcuate surface is concave.

5. The anti-pinch shield of claim 2, wherein said arcuate surface is configured to extend toward and terminate adjacent the trailing rear edge of the front passenger swing door when the front passenger swing door is in a closed position.

6. The anti-pinch shield of claim 5, wherein said arcuate surface is configured to extend from adjacent the trailing rear edge of the front passenger swing door, when the front passenger swing door is in the closed position, inwardly along the B-pillar and behind the leading front edge of the rear passenger swing door, when the rear passenger swing door is in a closed position.

7. The anti-pinch shield of claim 6, wherein said arcuate surface is configured to extend toward and terminate adjacent the leading front edge of the rear passenger swing door when the rear passenger swing door is in an open position.

8. The anti-pinch shield of claim 2, further including a second body having a second mount surface configured for attachment to the rear passenger swing door adjacent the leading front edge of the rear passenger swing door, said second body having a second arcuate surface facing opposite said second mount surface, said second arcuate surface having a second contour shaped for close matching travel along said arcuate surface of said first body as the rear passenger swing door moves between an open and closed position.

9. The anti-pinch shield of claim 8, wherein said arcuate surface of said first body is concave and said second arcuate surface is convex.

10. The anti-pinch shield of claim 1, wherein the leading front edge is on a front passenger swing door and the trailing rear edge of the adjacent vehicle panel is on a front vehicle panel, said first body being configured for attachment to an A-pillar of the motor vehicle adjacent the leading front edge and the trailing rear edge.

11. The anti-pinch shield of claim 1, wherein the arcuate surface is shaped for close matching travel of the leading front edge of the swing door along said arcuate surface as the swing door moves between an open and closed position.

12. A motor vehicle having at least one swing door pivotably attached to at least one of an A-pillar and a B-pillar of a vehicle body along a leading front edge of the swing door, and having an anti-pinch shield, comprising:
a first body having a mount surface configured for attachment to at least one of the B-pillar, between a trailing rear edge of a front passenger swing door and the leading front edge of a rear passenger swing door, and the A-pillar, between the leading front edge of the front passenger swing door and an adjacent front vehicle panel, said first body having an arcuate surface facing opposite said mount surface, said arcuate surface having a contour that matches an arc of travel of the leading front edge of the at least one swing door.

13. The motor vehicle of claim 12, wherein said first body is configured for attachment to the B-pillar in a location that blocks access to a grasping area of the trailing rear edge of the front passenger swing door when the front passenger swing door is in a closed position.

14. The motor vehicle of claim 13, wherein said first body has at least one through opening extending through said arcuate surface and said mount surface, said at least one through opening having a counterbore extending into said arcuate surface, said counterbore being configured for receipt of a head of a fastener therein to facilitate attachment of said first body to the B-pillar, with the head of the fastener being recessed from said arcuate surface.

15. The motor vehicle of claim 13, wherein said arcuate surface is concave.

16. The motor vehicle of claim 15, wherein said arcuate surface is configured to at least one of:
extend toward and terminate adjacent the trailing rear edge of the front passenger swing door when the front passenger swing door is in the closed position;
extend from adjacent the trailing rear edge of the front passenger swing door, when the front passenger swing door is in the closed position, inwardly along the B-pillar and behind the leading front edge of the rear passenger swing door, when the rear passenger swing door is in a closed position; and
extend toward and terminate adjacent the leading front edge of the rear passenger swing door, when the rear passenger swing door is in an open position.

17. The motor vehicle of claim 12, wherein the at least one swing door includes a grasp area provided on an inwardly facing surface of the at least one swing door.

18. The motor vehicle of claim 13, further including a second body having a second mount surface configured for attachment to the rear passenger swing door adjacent the leading front edge of the rear passenger swing door, said second body having a second arcuate surface facing opposite said second mount surface, said second arcuate surface having a second contour shaped for close matching travel along said arcuate surface of said first body as the rear passenger swing door moves between an open and closed position.

19. A method of blocking a potential pinch region between a leading front edge of a swing door and at least one of a trailing rear edge of an adjacent swing door and an adjacent vehicle panel of a motor vehicle, comprising:
providing a first body having a mount surface and an arcuate anti-pinch surface facing away from the mount surface; and
attaching the mount surface of the first body to a fixed body member of the motor vehicle, adjacent the leading front edge of the swing door, and adjacent at least one of the trailing rear edge and the adjacent vehicle panel.

20. The method of claim 19, further including providing the arcuate anti-pinch surface having a contour that matches an arc of travel of the leading front edge of the swing door.
